(19) United States
(12) Patent Application Publication
(10) Pub. No.: US 2015/0073958 A1
(43) Pub. Date: Mar. 12, 2015

(54) RESEARCH REPORT RECOMMENDATION ENGINE ("R+hu 3 +lE")

(71) Applicant: Bank of America Corporation, Charlotte, NC (US)

(72) Inventors: Graham E. Schweer, Lawrenceville, NJ (US); Sandeep Saini, New York, NY (US); Daire Browne, Brooklyn, NY (US)

(73) Assignee: Bank of America Corporation, Charlotte, NC (US)

(21) Appl. No.: 14/025,640

(22) Filed: Sep. 12, 2013

(51) Int. Cl. G06Q 40/00

(52) U.S. Cl. CPC G06Q 40/00
USPC 705/35

(57) ABSTRACT

A processor for providing a plurality of research reports to a pre-determined entity. The processor may rank a plurality of research reports based, at least in part, on the magnitude of times the research reports have been read by a group of peers of the pre-determined entity. The processor may assign a first score (r) to each of the research reports based on the ranking. The processor may also rank the plurality of research reports using multi-dimensional clustering and assign a second score based thereon (i). The processor may also rank the plurality of research reports using a trending metric and assign a third score (p) based thereon. The trending metric may be based on the amount of times the research reports were read in a pre-determined period. The processor may calculate a final report score for each research report according to the following equation:

$${\sum }_{w = 1}^{w = n} Final Report Score ( w ) = dp * ( r + i + p )$$

dp=a freshness of reports.

### FIELD OF TECHNOLOGY

This invention relates to providing research report recommendations. Specifically, this invention relates to providing research reports to pre-determined entities such as institutional portfolio managers, wealth management advisors and/or end-users (collectively hereinafter “pre-determined entity” or, in the plural, “pre-determined entities”).

### BACKGROUND OF THE DISCLOSURE

A large volume of research reports exist. Such research reports are nearly continuously being generated and published.

Typically, it is important to make available to the pre-determined entity the research reports that are most relevant reports to the pre-determined entity. Generally, pre-determined entities may subscribe to certain reports that the pre-determined entities consider relevant. It may be challenging to determine which generated and published reports should be made accessible to the pre-determined entities as supplement reports in which the pre-determined entities may show interest outside of their subscriptions.

It would be desirable for a financial institution to provide an engine that selects which research reports are relevant in order to make accessible supplemental reports to one or more of the pre-determined entities.

### SUMMARY OF THE DISCLOSURE

Systems and methods for ranking a plurality of research reports are provided. An apparatus may include a receiver configured to receive the plurality of research reports. The apparatus may also include a database to store the reports.

The apparatus may also include a processor. The processor may be configured to rank the plurality of research reports based, at least in part, on the magnitude of times the research reports have been downloaded and/or reviewed by a group of peers of a pre-determined entity. The processor may be further configured to rank the research reports and assign a first score to each of the plurality of research reports.

The processor may be further configured to rank the plurality of research reports using multi-dimensional clustering. The multi-dimensional clustering may be based, at least in part, on the proximity of the research report to a center of a multi-dimensional cluster. Based on the ranking using multi-dimensional clustering, the processor may assign a second score to each of the plurality of research reports.

The processor may be further configured to rank the plurality of research reports using a trending metric assigned to each of the plurality of research reports. The trending metric may be based on the amount of times the research reports were read in a second pre-determined time period. Based on the trending metric, the processor may be configured to assign a third score to each of the plurality of research reports.

The processor may be further configured to calculate a final report score for each research report. The final report score may be based, at least in part, on the sum of the first score, the second score and the third score.

The processor may be further configured to reduce the magnitude of each final report score based, at least in part, on the magnitude of elapsed time from publication of each research report.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows apparatus that may be used in accordance with the systems and methods of the invention;

FIG. 2 shows an illustrative flow diagram of data processing according to certain embodiments;

FIG. 3 shows an exemplary computer architecture that may be used to implement methods according to certain embodiments;

FIG. 4 shows an illustrative flow diagram that depicts a method according to certain embodiments;

FIG. 5A shows an exemplary chart for determining similarity between two members of a cluster; and

FIG. 5B shows a six-dimensional arrangement of vectors that may be used to determine proximity to a center including six vectors.

### DETAILED DESCRIPTION OF THE DISCLOSURE

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art upon reading the following disclosure, R³E processing may be embodied as a method, a data processing system, or a computer program product. Accordingly, R³E processing may take the form of an entirely hardware embodiment, an entirely software embodiment or an embodiment combining software and hardware aspects.

Furthermore, the R³E may take the form of a computer program product stored by one or more non-transitory computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

In an exemplary embodiment, in the event that R³E is embodied at least partially in hardware, the R³E processing may include one or more databases, receivers, transmitters, processors, modules including hardware and/or any other suitable hardware. Furthermore, the operations executed by R³E processing may be performed by the one or more databases, receivers, transmitters, processors and/or modules including hardware.

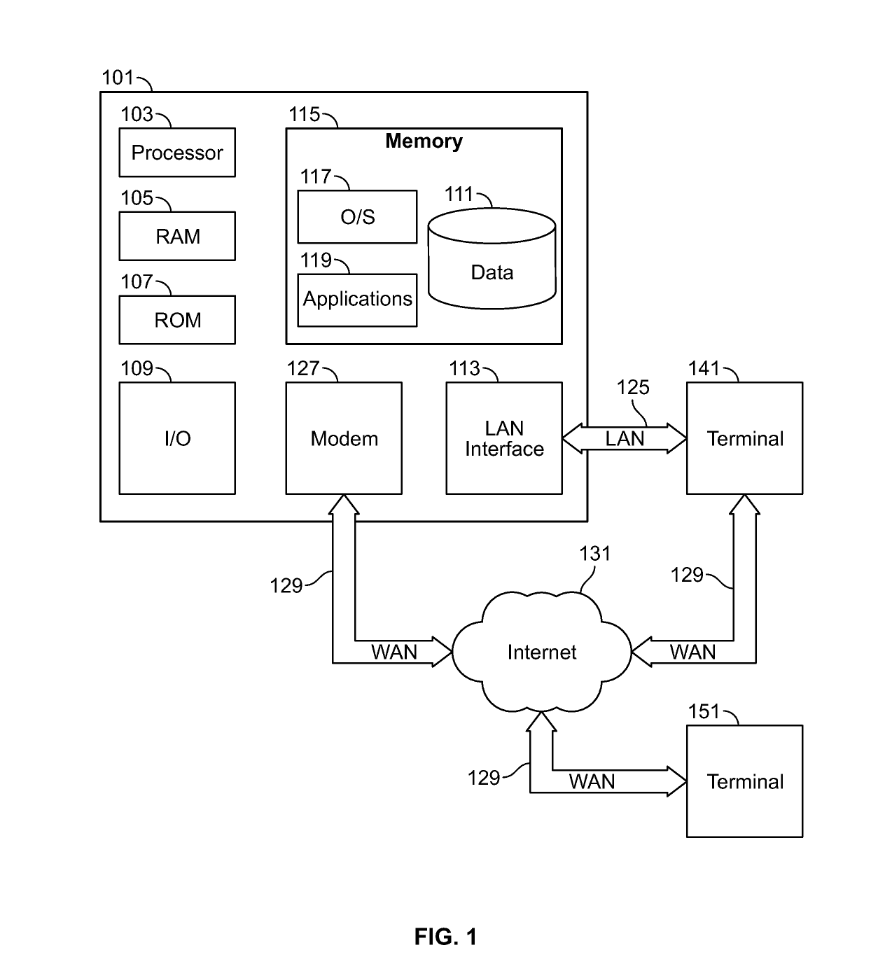

FIG. 1 is a block diagram that illustrates a generic computing device 101 (alternately referred to herein as a “server”) that may be used according to an illustrative embodiment of the invention. The computer server 101 may have a processor 103 for controlling overall operation of the server and its associated components, including RAM 105, ROM 107, input/output module (“I/O”) 109, and memory 115.

I/O module 109 may include a microphone, keypad, touch screen, and/or stylus through which a user of server 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternately, some or all of server 101 computer executable instructions may be embodied in hardware or firmware (not shown). As described in detail below, database 111 may provide storage for information input into an R³E according to the invention.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (“LAN”) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages via the World Wide Web from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A terminal such as 141 or 151 may be used by a user of an R³E to rank reports for transmission to a pre-determined entity. Information input for use with an R³E may be stored in memory 115. The input information may be processed by an application such as one of applications 119.

Apparatus for ranking a plurality of research reports is provided. The apparatus may include a processor. The processor may be configured to rank the plurality of research reports. The ranking of the research reports may be based, at least in part, on the magnitude of times the research reports have been reviewed by a group of peers of a pre-determined entity.

The identified group of peers may be established over a pre-determined time period. Based on the ranking of research reports, the processor may be configured to assign a first score to each of the plurality of research reports.

The processor may also being further configured to rank the plurality of research reports using multi-dimensional clustering. The ranking using multi-dimensional clustering may be based on the proximity of the research report to a center of a multi-dimensional cluster. Based on the ranking using multi-dimensional clustering, the processor may assign a second score to each of the plurality of research reports.

The processor may be further configured to rank the plurality of research reports using a trending metric. The trending metric may be calculated for each of the plurality of research reports. The trending metric may be based on the amount of times the research reports were read. The trending metric may be updated periodically. The update period may correspond to a preferably pre-determined time period. Based on the trending metric, the processor may assign a third score to each of the plurality of research reports.

The processor may be further configured to calculate a final report score for each research report. The final report score may be based, at least in part, on the sum of the first score, the second score and the third score.

The processor may be further configured to reduce the magnitude of each final report score. The processor may reduce the magnitude of each final report score based, at least in part, on the magnitude of elapsed time from generation and/or publication of each research report.

The group of peers may be formed from a cluster. The pre-determined entity may be the center of the cluster. The group of peers may be selected based on their respective proximity to the center of the cluster—i.e., the pre-determined entity for whom the reports are being selected—or to some other suitable central point. The proximity to the center of the cluster preferably provides a measure of similarity to the pre-determined entity. Other measures for determining similarity may also be used to determine this peer group.

The cluster may be clustered according to the report readership of the peers. In certain embodiments the cluster may have been formed based on co-occurrence of report readership among the peer group—e.g., proximity to the center the cluster may be determined based on how many of the same reports each of the peers has read.

The multi-dimensional cluster may include any suitable number of dimensions. The dimensions may include as few as two dimensions or as many as ten or even more. An exemplary list of dimensions may include dimensions such as asset class, industry, ticker, asset type, analyst and/or rating.

Each of the dimensions may preferably be assigned a value such that the asset classes may be used as a dimension in forming a multi-dimensional cluster. In certain embodiments, the values of the dimensions may be weighted in order to give more emphasis to one or more dimensions than to other dimensions in the multi-dimensional cluster.

Table 1 below shows an exemplary list of the members of selected dimensions.

TABLE 1
Exemplary List of Members of Dimensions (including exemplary weights)

| Industry (weight 1) | Asset Type (weight 2) | Rating (weight 3.5) |
|---|---|---|
| Advertising & Marketing | Agency Credit | Buy |
| Services | | |
| Aerospace | Asset Backed Credit | Neutral |
| Aerospace & Defense | Australia High Grade Bond Indices | Underperform |
| Aerospace/Defense Electronics | Balanced Funds | |
| Agricultural Machinery | Bond Funds | |
| Agricultural Operations | Canada High Grade Bond Indices | |
| Air Freight | Collateralized Debt | |
| | Obligations | |
| Airlines | Commodity Funds | |
| Airlines | Convertible | |
| Airports | Corporate High Yield | |
| | Credit | |
| Alternative Energy | Corporate Investment Grade | |
| | Credit | |
| Alternative Energy | Country Funds | |
| Apparel | Credit | |
| Appliances | Currency Cash | |
| Asset Management | Currency Derivatives | |
| Auto Parts | Currency Futures | |
| Automotive Manufacturers | Derivatives | |
| Automotive Suppliers | Emerging Markets Credit | |
| Autos | Emerging Markets | |
| | Sovereign | |
| Autos/Car Manufacturers | Equity Funds | |
| Bakers | European High Grade Bond | |
| | Indices | |
| Banks | European Covered Bond | |
| Banks | Financial Futures | |
| Banks Merchant | Global High Grade Bond | |
| | Indices | |
| Banks Multinational/Universal | Global High Yield & | |
| | Emerging Markets Bond | |
| | Indices | |
| Banks Retail | Japan High Grade Bond | |
| | Indices | |
| Banks US Regionals | Loans | |
| Bearings | Money Market Credit | |
| Beverages | Money Market Funds | |
| Beverages Alcoholic | Mortgage Backed Credit | |
| Beverages Soft Drinks | Municipal Credit | |
| Biotechnology | Provincial Regional Credit | |
| Bottlers | Publisher Defined | |
| Branded Consumer Services | Sovereign Credit | |
| Brewers | Stock | |
| Broadcasting | Supranational Credit | |
| Broadcasting | U.S. High Grade Bond | |
| | Indices | |
| Building | U.S. Municipal Securities | |
| | Indices | |
| Building & Construction | US Treasuries | |
| Building Construction | Agency Credit | |
| Building Materials | Asset Backed Credit | |
| Building Materials | Australia High Grade Bond | |
| | Indices | |
| Building Merchants | Balanced Funds | |
| Building Products | Bond Funds | |
| Bus Companies | Canada High Grade Bond | |
| | Indices | |
| Business Services | Collateralized Debt | |
| | Obligations | |
| Business Services | Commodity Funds | |
| Business Services | Convertible | |
| Cable | Corporate High Yield | |
| | Credit | |
| Cable TV | Corporate Investment Grade | |
| | Credit | |
| Car Rental | Country Funds | |
| Chemicals | Credit | |
| Chemicals | Currency Cash | |
| Chemicals Major | Currency Derivatives | |
| Chemicals Specialty | | |
| Coal | | |
| Coal | | |
| Commercial & Residential | | |
| Services | | |
| Computer Services | | |
| Connectors, Passive | | |
| Components & Distrib | | |
| Construction Machinery | | |
| Consumer Paper Products | | |
| Consumer Products | | |
| Consumer Products | | |
| Consumer Products Luxury | | |
| Retail | | |
| Containers | | |
| Convenience Stores | | |
| Cosmetics/Personal Care | | |
| Cruise Lines/Holiday | | |
| Companies | | |
| Data Networking | | |
| Death Care | | |
| Death Care | | |
| Defense Electronics | | |
| Distillers | | |
| Distributors | | |
| Distributors Electrical | | |
| Distributors Other | | |
| Distributors Vehicle | | |
| Diversified Operations | | |
| Drug Store Chains | | |
| Education & Training Services | | |
| Education & Training Services | | |
| Electric Utilities | | |
| Electric Utilities | | |
| Electrical Equipment | | |
| Electrical Equipment | | |
| Electronics | | |
| Electronics | | |
| Electronics | | |
| Electronics Manufacturing | | |
| Services | | |
| Electronics Major Diversified | | |
| & Others | | |
| Energy | | |
| Energy | | |
| Energy Commodities | | |
| Energy Technology | | |
| Engineering | | |
| Engineering | | |
| Engineering & Construction | | |
| Engineering & Construction | | |
| Entertainment | | |
| Fertilizers | | |
| Financial Services | | |
| Financial Services | | |
| Financial Services | | |
| Consumer/Commercial | | |
| Fixed Income Research | | |
| Food | | |
| Food | | |
| Food Processors | | |
| Food Producers | | |
| Food Producers | | |
| Food Service Businesses | | |
| Food Service Equipment | | |
| Food Canned | | |
| Food Commodities | | |
| Food Confectionery | | |
| Food Dairy Products | | |
| Footwear | | |
| Forest Products | | |
| Freight Forwarding | | |
| Gaming | | |
| Gaming | | |
| Gaming | | |
| Gas Utilities | | |
| Gas Utilities | | |
| Gold & Precious Metals | | |
| Government Sponsored | | |
| Agencies | | |
| Health Care | | |
| Health Care Distribution & | | |
| Technology | | |
| Healthcare | | |
| Homebuilders | | |
| Homebuilders | | |
| Hospital Management | | |
| Hotels | | |
| Household Products | | |
| Household Products | | |
| Housewares/Consumer | | |
| Durables | | |
| HydroElectric Utilities | | |
| Independent Power Producers | | |
| Industrial Machinery | | |
| Industrial Services/Equipment | | |
| Rental | | |
| Industrials/MultiIndustry | | |
| Industrials/MultiIndustry | | |
| Industrials/MultiIndustry | | |
| Information Processing | | |
| Insurance | | |
| Insurance Life | | |
| Insurance Multiline | | |
| Insurance NonLife | | |
| Interactive Media | | |
| Interior Furnishings | | |
| Internet Distributed Services | | |
| Internet Infrastructure Services | | |
| Internet/eCommerce | | |
| Investment Trusts | | |
| Investment Trusts | | |
| IT Hardware | | |
| Land Transport | | |
| (Warehousing/Logistics) | | |
| Leisure | | |
| Leisure | | |
| Leisure Hotel/Lodging | | |
| Leisure Time/Recreation | | |
| Lodging | | |
| Lodging | | |
| LongTerm Care | | |
| Luxury Goods | | |
| Machine Tools | | |
| Machinery/Diversified | | |
| Manufacturing | | |
| Managed Health Care | | |
| Manufactured Housing | | |
| Material Handling | | |
| Mechanical Engineering | | |
| Media & Entertainment | | |
| Media & Entertainment | | |
| Medical Specialty | | |
| Medical Supplies | | |
| Medical Technology | | |
| Metal Molding | | |
| Metals & Mining | | |
| Microcomputing | | |
| MidandSmall Cap Regional | | |
| Banks | | |
| Mortgage Finance | | |
| Music | | |
| Natural GasIntegrated | | |
| Natural GasLocal Distribution | | |
| Companies | | |
| Natural Gas Pipelines | | |
| NonFerrous Metals/Mining & | | |
| Minerals | | |
| NonFerrousAluminum & Light | | |
| Metals | | |
| Nonferrous Mining | | |
| Nonferrous Other | | |
| Oil & Gas | | |
| Oil & Gas Producers | | |
| Oil Refining & Marketing | | |
| Oil Services | | |
| Oils | | |
| Optics | | |
| Other Financials | | |
| Outsourcing Services | | |
| Packaging | | |
| Packaging | | |
| Packaging | | |
| Paper Products | | |
| Paper/Forest Products | | |
| Paper/Forest Products | | |
| PC Hardware | | |
| PC Software | | |
| Pharmaceuticals | | |
| Pharmaceuticals | | |
| Photography & Electronic | | |
| Imaging | | |
| Physician Practice | | |
| Management | | |
| Plantations | | |
| Plantations | | |
| Pollution Control | | |
| Pollution Control | | |
| Pollution Control | | |
| Printing Machinery | | |
| Print Related Services | | |
| Process Controls | | |
| Property/Developer | | |
| Publishing | | |
| Publishing | | |
| Pubs/Restaurants | | |
| Pulp | | |
| Rail Equipment | | |
| Rail Transport/Railroads | | |
| Real Estate/Property | | |
| Real Estate/Property | | |
| Real Estate/Property | | |
| REITs | | |
| REITs | | |
| REITs (Real Estate Investment | | |
| Trusts) | | |
| Renewable Energy | | |
| Restaurants | | |
| Restaurants | | |
| Restaurants | | |
| Retailing | | |
| Retailing | | |
| Retailing Book Chains | | |
| Retailing Broadline/ | | |
| Department Stores | | |
| Retailing Broadline/General | | |
| Merchandiser | | |
| Retailing Hardlines | | |
| RetailingSoftline | | |
| Retailing Softline | | |
| Retailing Specialty | | |
| Retailing Wholesale & | | |
| Logistics | | |
| Road Transport/Trucking | | |
| Royalty/Income Trusts | | |
| Royalty/Income Trusts | | |
| Satellite Services | | |
| Satellite Services | | |
| Savings & Loans/Thrifts | | |
| Sea Ports | | |
| Sea Transport | | |
| Securities Broker/Dealer | | |
| Semiconductor Capital | | |
| Equipment | | |
| Semiconductors | | |
| Semiconductors | | |
| Server & Enterprise Software | | |
| Services | | |
| Services Cyclical | | |
| Shipping | | |
| Soft Drinks | | |
| Software & IT Services | | |
| Specialty Steels | | |
| Specialty Wire & Cable | | |
| Spirits, Wines & Ciders | | |
| Sporting Goods | | |
| Steel | | |
| Steel | | |
| Steels | | |
| Supermarkets/Food Retailers | | |
| Support Services | | |
| Technical & Design Software | | |
| Technology | | |
| Technology | | |
| Technology Strategy | | |
| Telecom Equipment | | |
| Wireless/Cellular | | |
| Telecom Equipment Wireline | | |
| Telecom Infrastructure | | |
| Services | | |
| Telecom Services | | |
| Telecom ServicesCLECs | | |
| Telecom Services | | |
| Wireless/Cellular | | |
| Telecom Services Wireline | | |
| Telecommunications | | |
| Textile Products | | |
| Textiles/Apparel | | |
| Textiles/Apparel | | |
| Theaters | | |
| Tires | | |
| Tobacco | | |
| Tobacco | | |
| Tobacco | | |
| Toll Road Operators | | |
| Toys | | |
| Transport/Infrastructure | | |
| Transportation | | |
| Truck/Bus Manufacturers | | |
| Trust Banks | | |
| Utilities | | |
| Utilities | | |
| Utilities Other | | |
| Water Utilities | | |

The trending metric may be based on a review of which research reports have been recently read. For example, the trending metric may be updated based on research reports read in the previous 15 minutes. In certain embodiments, the trending metric may be derived from information written to a real-time readership log. It should be noted that a determination of the trending metric is preferably agnostic to, or alternatively, independent of, the identity of the report readers and/or reviewers.

In certain embodiments of the invention, one or more of the first score, the second score and the third score may be weighted. Such a weighting may change the effect of the weighted score on the final report score.

In certain embodiments, the processor may be configured to filter out reports that have previously been made accessible to the pre-determined entity.

In certain embodiments, the processor may be further configured to provide a selected group of the pre-determined number of research reports to the pre-determined entity based, at least in part, on the final report score.

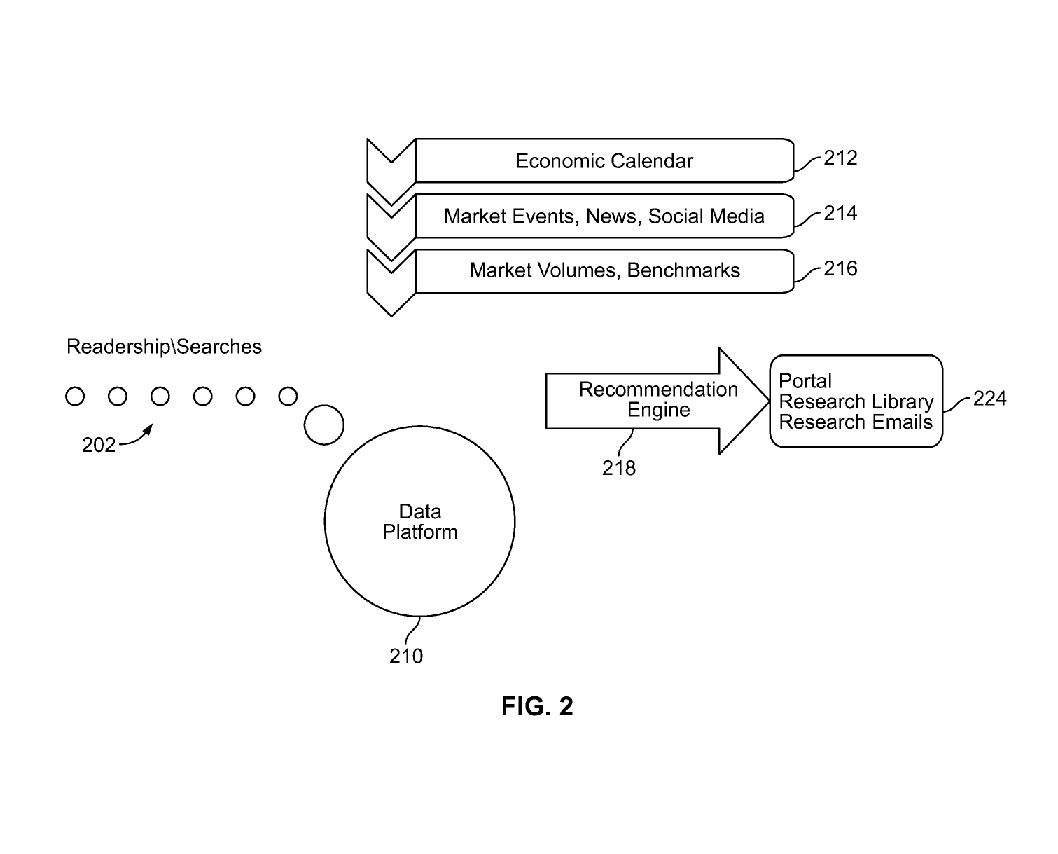

FIG. 2 shows an illustrative flow diagram 200 of data processing according to certain embodiments. Such data may include readership/research library/search data that may be transformed according to certain embodiments.

Flow diagram 200 shows readership/search inputs 202 into a data platform 210. Other inputs may include the economic calendar 212, market events, news and/or social media 214 and market volumes, benchmarks (such as the Ten-Year U.S. Treasury Bond Interest Rate, the Libor (London Interbank Offered Rate) 216.

Platform 210 may be used to receive, organize and/or transfer the data to recommendations engine 218. Engine 218 may preferably receive the data. Based on the data, engine 218 may make accessible a suitable number of selected, recommended, research reports via a portal or research library (which may be accessed using a user login ID and password, or other suitable identifier.) Engine 218 may provide a suitable number of selected, recommended, research reports directly by providing access to the research reports to pre-determined entities.

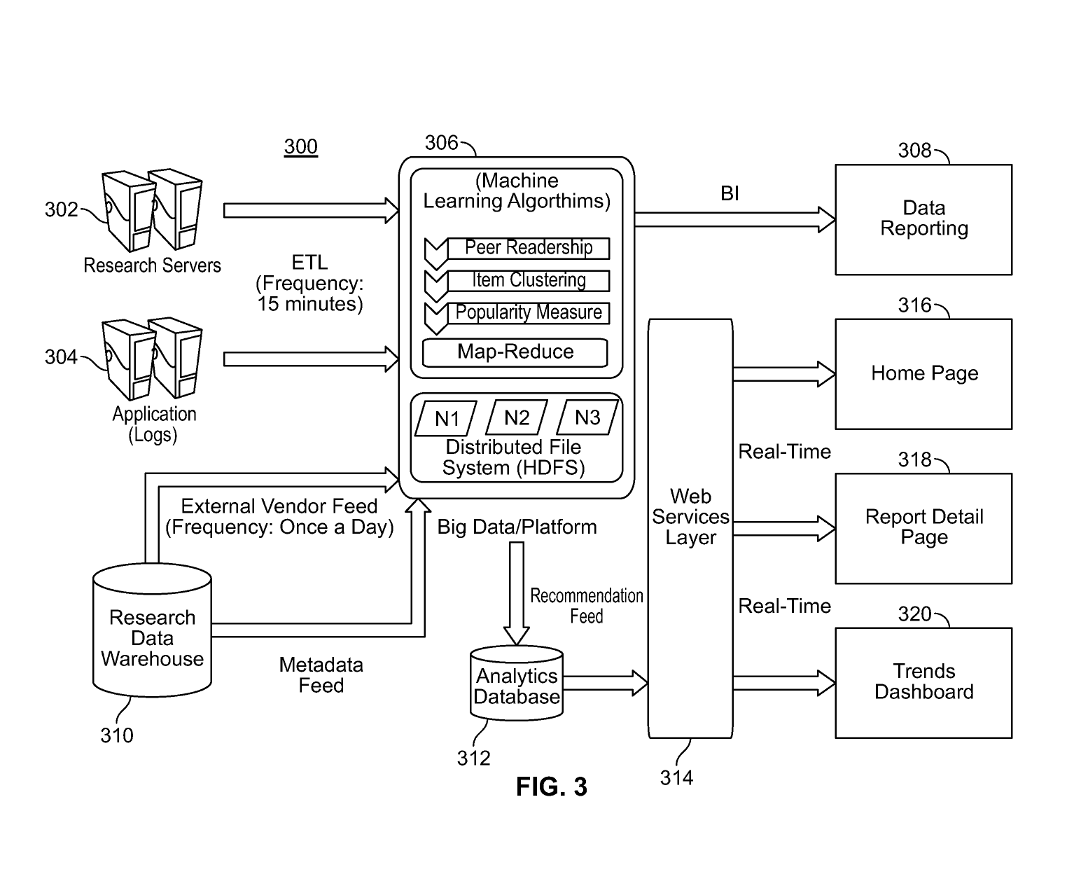

FIG. 3 shows an exemplary computer architecture 300 that may be used to implement methods according to the invention. Architecture 300 may use research servers 302 and/or other applications (logs) 304 to extract, transform and/or load (“ETL”) information into a data platform 306. FIG. 3 shows an exemplary ETL frequency of 15 minutes but any suitable frequency may be implemented.

Architecture 300 may also implement research data warehouse 310. Warehouse 310 may forward an external data feed with a frequency of once a day or other suitable frequency and a metadata feed to data platform 306. The external data feed may include information required for various cluster calculations, as set forth in more detail below. For example, the external data feed may include metadata associated with a report such as which analyst prepared the report, which industry is associated with the report and other such suitable metadata for association with each report.

Data platform 306 may preferably transmit the loaded information for data reporting 308 and/or to an analytics database 312. Data reporting 308 may provide information regarding the number of reports being made accessible to pre-determined entities. Data reporting may provide information for building a reporting dashboard or other suitable reporting display. Such display (not shown) may be used to show various statistics and/or other information regarding data reporting.

Database 312 may preferably include a history of all reports that have, heretofore, been made available to pre-determined entities. Such a history may be useful in determining which reports to filter out of future rankings and/or future communications with pre-determined entities. Web Services Layer 314 may preferably receive information from database 312.

Web Services Layer 314 may then prepare the information for transmission to a web service. Once the information is prepared, Web Services Layer 314 may then transmit the information to one or more of the home page 316, report detail page 318 and/or trends dashboard 320, or other similar web-based page display.

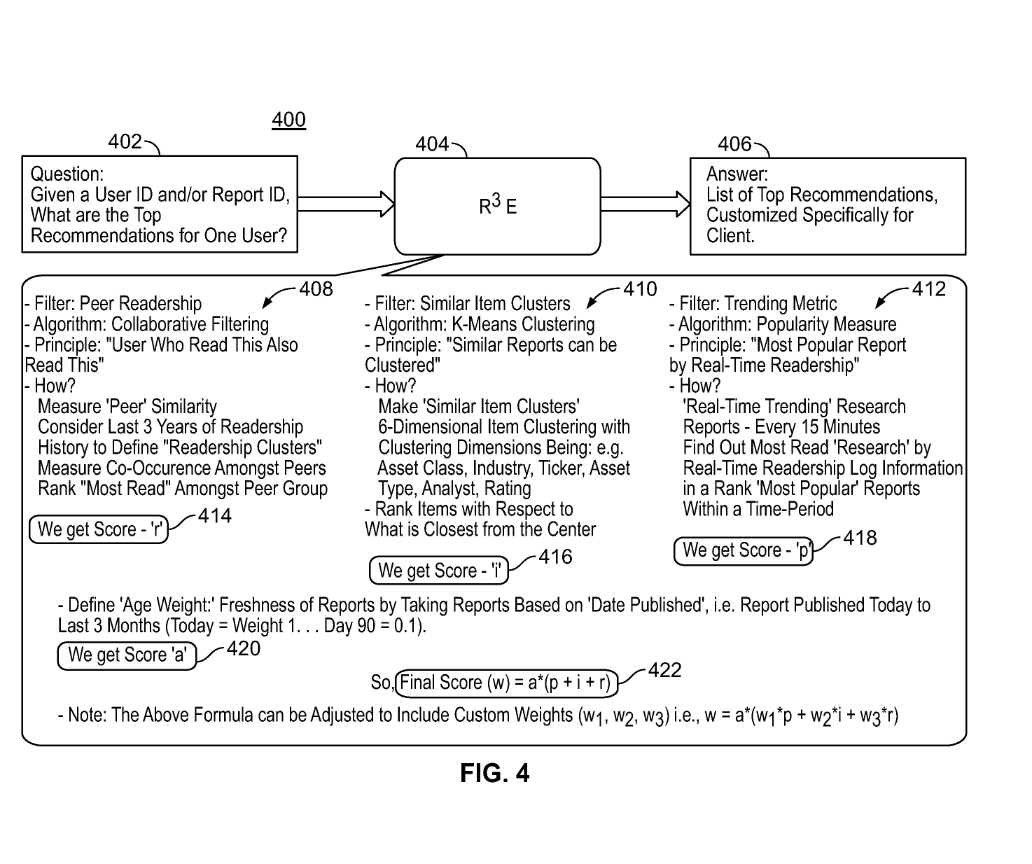

FIG. 4 shows an illustrative flow diagram 400 that depicts a method according to the invention. Flow diagram 400 begins with a query, 402, which poses the following question—“Given a User ID and/or a Report ID, what are the top research report recommendations (e.g., the selected group of the highest ranking reports) for the user?” The user ID may correspond to various user attributes such as peer group. Such attributes, as will be explained further below with respect to peer readership clusters 408, may allow the system to use the pre-determined entity, such as a system user, as a cluster center in order to customize the selection of the reports sent to the pre-determined entity.

Attributes of the identified report, as will be explained below with respect to similar item clusters 410, may also be used as a cluster center in order to customize the selection of the reports sent to the pre-determined entity. Accordingly, attributes of the pre-determined entity and attributes of the report may operate to be included with other analyses by R³E 404 in determining which reports should be sent to the pre-determined entity.

Peer readership filter 408 may preferably include an algorithm for collaborative filtering of reports. For the purpose of this application, the term collaborative filtering should be understood to refer to filtering reports based on “collaborating” the readership of different clients. Such collaborating preferably may be used to rank the research reports. The ranking based on the peer group preferably ranks highest the reports that have been read the most by the pre-determined entity's peer group. Such a ranking may preferably assign values to the reports. The values assigned to the reports preferably correspond to the relevance of the report readership to the pre-determined entity's readership.

In one embodiment, peer similarity of the pre-determined entity to the group may be obtained based on creating a readership cluster. In such a cluster, the pre-determined entity's report readership may represent the center of the cluster.

The other cluster members may be organized with respect to their respective proximity to the center. The proximity to the center of the cluster may be determined by the similarity of the readership of the other members of the cluster to the readership of the pre-determined entity. For example, such similarity may be based on co-occurrence of report readership among members of the peer group.

Such similarity may be determined in view of a pre-determined readership sample. Such a sample may be taken over a time period such as two (2) years or some other suitable time period.

Following a determination of peer similarity, the reports may preferably include a value, or alternatively, a score, that corresponds to the relevance of the report to the pre-determined entity.

Similar items clusters 410 may preferably be derived using an algorithm for filtering reports based on any number of suitable means. The principle behind such clustering is that similar reports can be clustered. Such clustering preferably may be used to rank the reports based on the similarity of the reports to reports already reviewed by the pre-determined entity or based on the similarity of the reports to some other group of reports. Such clustering may be used to rank the reports based on the similarity of the reports to a single report that was recently read by the pre-determined entity.

In certain embodiments, the clusters of reports may be determined with respect to a multi-dimensional cluster center formed from a plurality of dimensions. The dimensions may include six or more dimensions. Such dimensions may include asset class, industry, ticker, asset type, analyst and/or rating. The information for the dimensions forming the center of the cluster may include information derived from a single report reviewed by the pre-determined entity. The information for the dimensions forming the center of the cluster may include information derived from a plurality of reports reviewed by the pre-determined entity.

Following the arrangement of reports in a multi-dimensional cluster, the reports may preferably include a value, or alternatively, a score, that corresponds to the relevance of the report to center of the multi-dimensional cluster.

An additional means for determining relevance of reports to a reader may include a filter for determining a trending metric filter 412. The principle behind determining a trending metric may include ranking the reports according to substantially real-time, preferably non-peer based, readership. In certain alternative embodiments, the trending metric may include determining the ranking based on peer-based, substantially real-time, readership.

In certain embodiments, trending metric filter 412 may include ranking each of the reports based on the magnitude of report review occurrences in a preferably substantially continuously, or, alternatively, periodically, updated pre-determined window of time. For example, trending metric filter 412 may be determined based on monitoring every 15 minutes. Monitoring may include monitoring for report review.

When such monitoring occurs continuously, then the monitoring may preferably implement a window looking back over the pre-determined time period such that the monitoring substantially continuously ranks the reports based on the historical readership. In some embodiments, the window of historical readership may be based on what was read and may be updated once every 15 minutes. As such, articles that were read in the last 15 minutes would obtain a positive change in trending metric value, or score.

Such monitoring may be implemented using information obtained from a real-time readership log. Such a real-time readership log may preferably be stored in servers 302 and/or in logs stored in applications 304. In certain embodiments, trending metric filter 412 may have the effect of increasing the final score of the reports that have been reviewed within a pre-determined, preferably sliding, window of time.

In certain embodiments of the invention, the score derived from the peer readership filter 408 for each report, the score derived from the similar item clusters 410 for each report and the score derived from the trending metric filter 412 for each report may preferably be summed in order to determine a final score for each report.

The final report may preferably be assigned a publication date. The publication date may preferably be used to determine the “freshness” of the report. In one embodiment, a weight may be assigned to the freshness determination. The final score may be multiplied by the weight associated with the freshness report in order to adjust the report based on its individual age.

In one embodiment, a report that issued today may be assigned a freshness weight of 1.0. The freshness weight of 1.0, in some embodiments, does not effect a change on the final report score.

A report that published prior to the determination of the final report score may be assigned a freshness weight of some value substantially less than 1. It should be noted, however, that any suitable numeric range, and/or numeric scale may be implemented for the weighting system in order to obtain a desirable final report score which takes report freshness into account.

In some embodiments, each of the first score, the second score and/or the third score may be weighted in order to add emphasis to, or remove emphasis from, one or more of the peer readership filter 408, the similar items cluster 410 and/or the trending metric filter 412.

Preferably, following the determination of the final, preferably adjusted and/or weighted, final reports scores, a pre-determined number of reports may be transmitted to the pre-determined entity. In certain embodiments, notification may be transmitted to the entity which alerts the entity that a pre-determined number of research reports have been determined to be relevant to him and are available for his review.

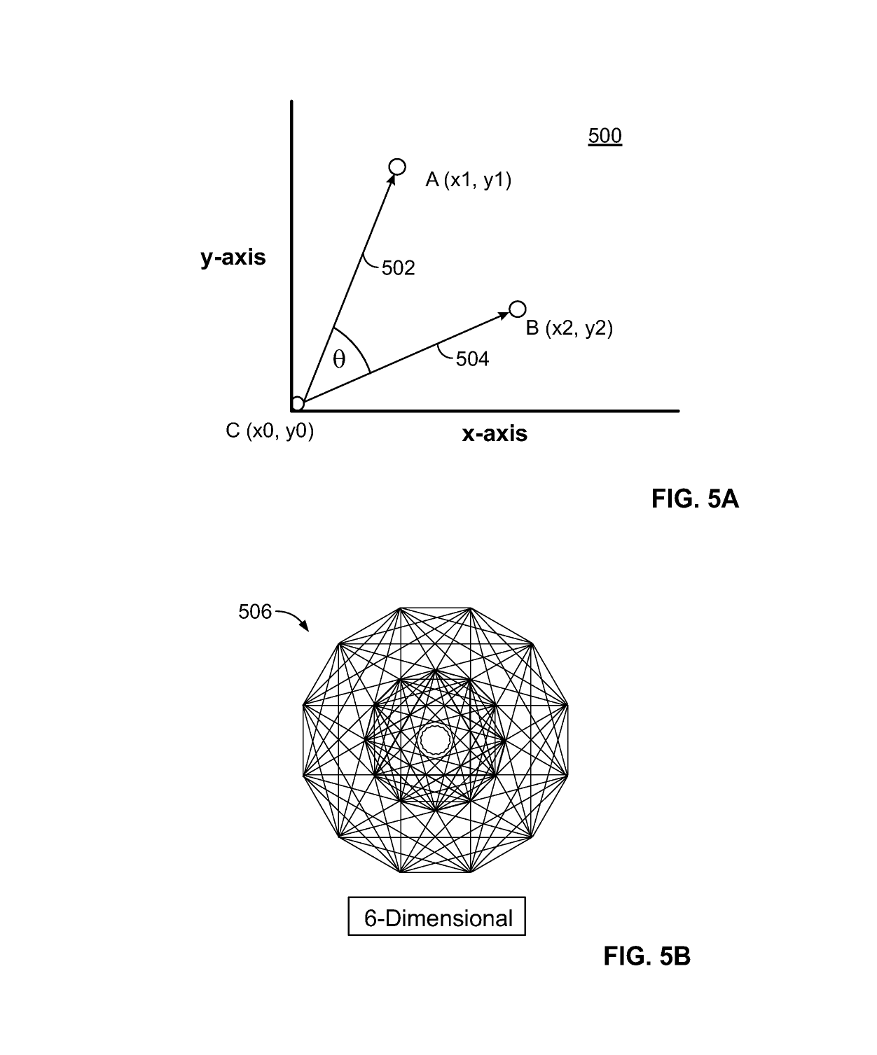

FIG. 5A shows an exemplary chart for determining similarity. With respect to the present invention such a similarity determination may be used to implement the peer readership filter 408 and or the similar items cluster 410.

Vector A 502 may include components (x1, y1), and may be understood to indicate direction and magnitude. Vector B 504 may include components (x2, y2). Such vectors are shown in FIG. 5A in two dimensions—i.e., with two components. It should be noted, however, that such similarity determinations may be made in more than two dimensions e.g., three, four, five, six or more dimensions.

For the purposes of the application, θ may be considered to be the angle between vectors 502 and 504. Cosine similarity may be used to determine the similarity of the vectors. It should be noted that any suitable mathematical function for defining similarity between two vectors may be used.

Cosine similarity may be obtained using the following equation:

$$Sim ( A , B ) = cosine θ = \frac{A \cdot B}{\vert A \vert \vert B \vert} = \frac{x {1}^{*} x 2 + y {1}^{*} y 2}{{( x {1}^{2} + y {1}^{2 } )}^{1 / 2} {( x {2}^{2} + y {2}^{2} )}^{1 / 2}}$$

The value of cos θ varies between −1 and +1. At −1, the vectors are 180° apart and are absolutely dissimilar, obtaining an opposite-ended vector relationship. At 0, the vectors are 90° apart and are dissimilar, obtaining a perpendicular relationship. At +1, the vectors are aligned and are absolutely similar, obtaining an overlapping relationship. It should be noted that such a similarity equation could be expanded, as is known in the art, to determine vector similarity based on any suitable number of vector components.

Examples of forming peer readership clusters may include identifying peers that have read the greatest number of the same material—e.g., previously transmitted reports—as the pre-determined entity. In such a cluster determination, the pre-determined entity's report readership may form the center of the cluster.

The proximity to the center of another entity's readership may be characterized by comparing the number of reports that the pre-determined entity and the entity being ranked have reviewed. Such a number may be used to form a uni-dimensional measure which can then be used to rank the other entity in order to determine whether the other entity should be considered a peer.

Once a group of peers is formed, methods may include determining which reports have been reviewed most by the peer group. From the group of most read reports, the system may preferably remove the reports reviewed by pre-determined entity (this step may occur at any suitable time either before, during or after the determination of the most read reports). Thereafter, the system may rank the reports that have been reviewed most by the group of peers.

Calculating similarity between items for establishing similar items cluster 410 may also be implemented using cosine similarity. For example, a center may be obtained based on reports read by the pre-determined entity.

The center of similar items cluster 410 may be defined by vector values most similar to the reports read by the pre-determined entity. Once the center has been obtained, and defined by a group of vectors, the remaining reports may be ranked with respect to proximity to a group of vectors at the center. In such a method, definition of the vectors may be weighted and/or changed to emphasize one or more characteristics of the pre-determined entity.

FIG. 5B shows a six-dimensional arrangement of vectors that may be used to determine proximity to a center created from six vectors associated with the pre-determined entity.

Thus, methods and apparatus for implementing an R³E in accordance with the systems and methods of the invention have been provided. Persons skilled in the art will appreciate that the present invention can be practiced in embodiments other than the described embodiments, which are presented for purposes of illustration rather than of limitation, and that the present invention is limited only by the claims that follow.

What is claimed is:

1. Apparatus for ranking a plurality of research reports, the apparatus comprising:
a receiver configured to receive the plurality of research reports;
a processor configured to rank the plurality of research reports based, at least in part, on the magnitude of times the research reports have been downloaded by a group of peers of a pre-determined entity, and, based on the ranking of research reports, assign a first score to each of the plurality of research reports;
the processor being further configured to rank the plurality of research reports using multi-dimensional clustering, the ranking using multi-dimensional clustering, the ranking based, at least in part, on the proximity of the research report to a center of a multi-dimensional cluster, and based on the ranking using multi-dimensional clustering, assign a second score to each of the plurality of research reports; and
the processor being further configured to rank the plurality of research reports using a trending metric assigned to each of the plurality of research reports, the trending metric being based on the amount of times the research reports were read, the trending metric being updated periodically, and, based on the trending metric, to assign a third score to each of the plurality of research reports;
the processor being further configured to calculate a final report score for each research report, the final report score being based, at least in part, on the sum of the first score, the second score and the third score; and
the processor being further configured to reduce the magnitude of each final report score based, at least in part, on the magnitude of elapsed time from publication of each research report.

2. The apparatus of claim 1 wherein the group of peers is clustered according to the report readership of the peers.

3. The apparatus of claim 2 wherein the ranking based on the magnitude of times each of the research reports has been read by a group of peers is based further on co-occurrence of report readership among the peer group.

4. The apparatus of claim 1 wherein the multi-dimensional cluster consists of at least three dimensions selected from the group of asset class, industry, ticker, asset type, analyst and rating.

5. The apparatus of claim 1 wherein the trending metric is updated every 15 minutes or less.

6. The apparatus of claim 1 wherein the trending metric is based, at least in part, on information written to a real-time readership log.

7. The apparatus of claim 1 wherein each of the first score, the second score and the third score may be weighted individually to change its respective effect on the final report score.

8. The apparatus of claim 9 wherein the processor is further configured to filter out reports that have previously been transmitted to the pre-determined entity.

9. The apparatus of claim 1 wherein the processor is further configured to provide the plurality of the pre-determined number of research reports to the pre-determined entity based, at least in part, on the final report score.

10. An article of manufacture comprising a non-transitory computer usable medium having computer readable program code embodied therein, the code when executed by a processor causes a computer associated with a financial institution to provide a plurality of research reports to a pre-determined entity, the computer readable program code in said article comprising:
computer readable program code for causing the computer to rank a plurality of research reports based, at least in part, on the magnitude of times the research reports have been read by a group of peers of the pre-determined entity, and, based on the ranking, assign a first score (r) to each of the plurality of research reports;
computer readable program code for causing the computer to rank the plurality of research reports using multi-dimensional clustering, said ranking using multi-dimensional clustering for arranging the plurality of research reports with respect to proximity to a center of a multi-dimensional cluster, and, based on the ranking using the multi-dimensional clustering, assign a second score (i) to each of the plurality of research reports;
computer readable program code for causing the computer to rank the plurality of research reports using a trending metric assigned to each of the plurality of research reports, the trending metric representing the magnitude of times the research reports were reviewed, the trending metric being updated following a pre-determined time period, and, based on the ranking using the trending metric, assign a third score (p) to each of the plurality of research reports; and
computer readable program code for causing the computer to calculate a final report score for each research report according to the following equation:
$${\sum }_{w = 1}^{w = n} Final Report Score ( w ) = dp * ( r + i + p )$$
wherein dp=a freshness of reports determination based, at least in part, on the date of publication of the research report, wherein the magnitude of dp decreases over time.

11. The article of claim 10 wherein the group of peers is clustered according to the report readership of the peers.

12. The article of claim 11 wherein the ranking based on the magnitude of times the research reports have been read by a group of peers is further based, at least in part, on co-occurrence of report readership among the peer group.

13. The article of claim 10 wherein the multi-dimensional cluster consists of at least three dimensions selected from the group of asset class, industry, ticker, asset type, analyst and rating.

14. The article of claim 10 wherein the predetermined time period is 15 minutes or less.

15. The article of claim 10 wherein the trending metric is based, at least in part, on information written to a real-time readership log.

16. The article of claim 10 wherein w is adjustable by at least one of w₁, w₂ and w₃ such that:
$${\sum }_{w = 1}^{w = n} Final Report Score ( w ) = dp * ( {w}_{1} r + {w}_{2} i + {w}_{3} p )$$

17. The article of claim 10 wherein the processor is further configured to filter out reports that have previously been transmitted to the pre-determined entity.

18. The article of claim 10 wherein the processor is further configured to provide the pre-determined number of research reports to the pre-determined entity based, at least in part, on the final report score of the pre-determined number of research reports.
